(19) United States
(12) Patent Application Publication
(10) Pub. No.: US 2026/0300912 A1
(43) Pub. Date: Oct. 1, 2026

(54) STORAGE CONTAINER ORGANIZATION

(71) Applicant: AutoStore Technology AS, Nedre Vats (NO)

(72) Inventors: Jørgen Heggebø, Langhus (NO); Asheesh Saraswat, Heggedal (NO)

(21) Appl. No.: 19/477,905

(22) PCT Filed: Jan. 22, 2024
(86) PCT No.: PCT/EP2024/051350

§ 371 Date: Oct. 23, 2025

(30) Foreign Application Priority Data
Apr. 28, 2023 (NO) 20230492

(51) Int. Cl. G06Q 10/087

(52) U.S. Cl. CPC G06Q 10/08726; G06Q 10/08741

(57) ABSTRACT

A method and system for pre-organizing products stored in storage containers (106) in an automated storage and retrieval system (1). The method comprises identifying one or more correlations or correlation parameters between different products, and where correlations are found, pre-organizing the products stored in a plurality of the storage containers (106) by instructing picking operations that group products together in those storage containers (106) so that the pre-organized storage containers (106) contain combinations of products that have been identified to be more likely ordered together in a future product order according to the at least one or more correlation parameters identified between different products. The pre-organizing may be performed by an organizer module (400) configured to detect dynamic dependencies and correlations between products or storage containers (106), and which is configured to send instructions to a warehouse management system (401) which controls execution of the pre-organizing at a picking location (402) where the storage containers (106) are made available.

### FIELD OF THE INVENTION

The present invention relates to an automated storage and retrieval system for storage and retrieval of storage containers holding products, and more specifically to a method, system, and computer program product for organizing products stored in storage containers.

### BACKGROUND

Storage and retrieval systems are well known. Vehicles operating these are controlled by a central controller of a Warehouse Management System, WMS, 401, communicating with controllers in each vehicle.

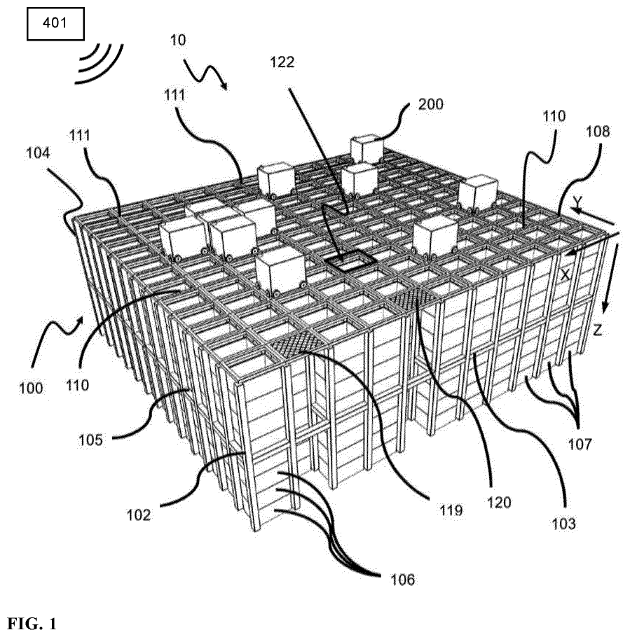

FIG. 1 illustrates a typical prior art automated storage and retrieval system 10 having a framework structure 100 and where container handling vehicles 150, also called robots, are operating the automated storage and retrieval system 10 when running on a rail system 108 on top of the framework structure 100.

The framework structure 100 comprises a plurality of upright members 102 and optionally a plurality of horizontal members 103 supporting the upright members 102. The members 102, 103 may typically be made of metal, e.g. extruded aluminium profiles.

The framework structure 100 defines a storage grid 104 comprising storage columns 105 arranged in vertical rows, in which storage containers 106, also known as bins, are stacked one on top of another to form stacks 107. Each storage container 106 may typically hold a plurality of product items.

The automated storage and retrieval system 10 comprises a rail system 108 for guiding container handling vehicles 150. The rail system 108 is arranged in a grid pattern across the top of the storage grid 104. The container handling vehicles 150 run on the rail system 108 and are operated to lower and raise storage containers 106 into and from the storage columns 105 as well as transporting the storage containers 106 on the rail system 108. The horizontal extent of a storage column 105 is defined by a grid cell 122 marked by thick lines in FIG. 1. Grid cells 122 define the layout of the rail system 108.

The rail system 108 comprises a first set of parallel rails 110 arranged to guide movement of the container handling vehicles 150 in a first direction X across the top of the frame structure 100, and a second set of parallel rails 111 arranged perpendicular to the first set of rails 110 to guide movement of the container handling vehicles 150 in a second direction Y which is perpendicular to the first direction X. In this way, the rail system 108 defines grid columns above which the container handling vehicles 150 can move laterally above the storage columns 105, i.e. in a plane which is parallel to the horizontal X-Y plane.

Each container handling vehicle 150 comprises a vehicle body and a wheel arrangement of eight wheels where a first set of four wheels enable the lateral movement of the container handling vehicles 150 in the X direction and a second set of the remaining four wheels enable the lateral movement in the Y direction. One or both sets of wheels in the wheel arrangement can be lifted and lowered, so that the first set of wheels and/or the second set of wheels can be engaged with a respective set of rails 110, 111A vehicle controller in the container handling vehicle 150 controls the wheels via driving means to provide controlled directional movements of the container handling vehicle 150.

Each container handling vehicle 150 further comprises a lifting device (not shown) for vertical transportation of storage containers 106, e.g. raising a storage container 106 from, and lowering a storage container 106 into, a storage column 105. The lifting device comprises one or more gripping/engaging devices (not shown) adapted for engaging a storage container 106. The gripping/engaging devices can be lowered from the vehicle 150 by the lifting device for adjusting the position of the gripping/engaging devices in a third direction Z which is orthogonal the first and second directions X, Y.

Each container handling vehicle 150 comprises a storage compartment or space (not shown) for receiving and stowing a storage container 106 when transporting the storage container 106 across the rail system 108. The storage space may comprise a cavity arranged centrally within the vehicle body. Alternatively, the container handling vehicles 150 may have a cantilever construction where a storage container 106 is handled next to the vehicle body.

In a storage grid 104, most of the grid columns are storage columns 105, i.e. grid columns 105 where storage containers 106 are stored in stacks 107. However, a storage grid 104 normally has at least one grid column which is not used for storing storage containers 106, but instead is used by the container handling vehicles 150 for dropping off and/or picking up storage containers 106 so that they can be transported to a second location (not shown) where the storage containers 106 can be accessed from the outside of the storage grid 104 or transferred out of or into the storage grid 104. Within the art, such a location is normally referred to as a “port” and the grid column in which the port is located may be referred to as a “delivery column” 119. The drop-off and pick-up ports of the container handling vehicles 150 are referred to as the “upper ports of a delivery column” 119. While the opposite end of the delivery column is referred to as the “lower ports of a delivery column”.

The storage grids 104 in FIG. 1 comprise two delivery columns 119 and 120. The first delivery column 119 may for example comprise a dedicated drop-off port where the container handling vehicles 150 can drop off storage containers 106 to be transported through the delivery column 119 and further to an access or a transfer station (not shown), and the second delivery column 120 may comprise a dedicated pick-up port where the container handling vehicles 150 can pick up storage containers 106 that have been transported through the delivery column 120 from an access or a transfer station (not shown). Each of the ports of the first and second delivery column 119, 120 may comprise a port which is suitable for both pick-up and drop-off storage containers 106.

The second location, where a storage container 106 can be accessed from the outside of the storage grid 104, may typically be a picking or a stocking station where product items are removed from or positioned into the storage containers 106. In a picking or a stocking station, the storage containers 106 are normally never removed from the automated storage and retrieval system 10 but are returned into the storage grid 104 once accessed. For transfer of storage containers out of, or into the storage grid 104, there are also lower ports provided in a delivery column. Such lower ports are for example used for transferring storage containers 106 to another storage facility (e.g. to another storage grid), directly to a transport vehicle (e.g. a train or a lorry), or to a production facility.

For monitoring and controlling the automated storage and retrieval system 10, the system comprises a central control system of a Warehouse Management System, WMS, 401 which typically is computerized and comprises a database for keeping track of the location of the storage containers 106 as well as which storage container 106 to be handled at any time, i.e. which storage container 106 to be retrieved or stored in the storage grid 104. In addition to this, the control system monitors and controls the positions and movements of each container handling vehicle 150 operating on the storage grid 104. In this way, each container handling vehicle 150 receives movement instructions from the control system for transporting a specific storage container 106 from one location to another location without colliding with each other.

For controlling the traffic flow of the container handling vehicles 150 operating on the storage grid 104, the WMS has at all times an updated overview of positions and movements of all container handling vehicles 150.

When a storage container 106 stored in the storage grid 104 disclosed in FIG. 1 is to be accessed, a control system may for instance instruct one of the container handling vehicles 150 to retrieve the storage container 106 from its current location in the storage grid 104 and to transport it to or through the first delivery column 119. This operation involves moving the container handling vehicle 150 to a grid location above the storage column 105 in which the target storage container 106 is located, retrieving the storage container 106 from the storage column 105 using the container handling vehicle's lifting device (not shown), and transporting the storage container 106 to the first delivery column 119. If the target storage container 106 is located deep within a stack 107, i.e. with one or a plurality of other storage containers stacked above the target storage container 106, the operation will include temporarily moving the storage containers 106 above the target storage container 106 prior to lifting the target storage container 106 from the storage column 105. This step, which is sometimes referred to as “digging” within the art, may be performed with the same container handling vehicle 150 that is subsequently used for transporting the target storage container 106 to the delivery column, or with one or a plurality of other cooperating container handling vehicles 150. Alternatively, or in addition, the automated storage and retrieval system 10 may have container handling vehicles 150 specifically dedicated to the task of temporarily removing storage containers 106 from a storage column 105. Once the target storage container 106 has been removed from the storage column 105, the temporarily removed storage containers 106 can be repositioned into the original storage column 105 or alternatively be relocated to other storage columns 105.

When a storage container 106 is to be stored in the storage grid 104, one of the container handling vehicles 150 is instructed to pick up the storage container 106 from the second delivery column 120, shown in FIG. 1, and to transport it to a grid location above the storage column 105 where it is to be stored. After any storage containers 106 positioned at or above the target position within the storage column stack 107 have been removed, the container handling vehicle 150 places the storage container 106 at the desired location. The removed storage containers 106 may then be lowered back into the storage column 105 or relocated to other storage columns 105.

The Warehouse Management System, WMS, 401, transmits operation and movement instructions to all container handling vehicles 150 for controlling all movements and operations on a storage and retrieval system 10. For doing so, the WMS 401 will at all times have a total overview of the locations of all vehicles 150 operating the storage and retrieval system 10 as well as the locations of all storage containers 106. The WMS 401 instructs each vehicle 150 to store or retrieve storage containers 106. The current position of each vehicle is continuously communicated from a vehicle 150 to the WMS 401, thus enabling it to control the movements of all vehicles 150 on the rail system 108 in an optimal way without vehicles 150 queuing or colliding.

Routing of container handling vehicles 150 performing jobs, such as moving a storage container from one position to another, is a vital part of controlling an automated storage and retrieval system 10.

Picking of different products from storage containers according to orders, will normally require picking of each type of product stored in different containers. As a consequence, when picking different products, response times can be slow, energy consumption can be high and the traffic flow of container handling vehicle can be high as well.

### SUMMARY OF THE INVENTION

This summary is provided to introduce in simplified form a selection of concepts that are further described herein. The summary is not intended to identify key or essential features of the invention.

The present invention is method, computer program product and system as defined in the main claims and with additional features defined in dependent claims.

More specifically, the invention is defined by a method of pre-organizing products stored in storage containers in an automated storage and retrieval system.

The method comprises identifying one or more correlations or correlation parameters between different products, and where correlations are found, pre-organizing the products stored in a plurality of the storage containers by instructing picking operations that group products together in those storage containers so that the pre-organized storage containers contain combinations of products that have been identified to be more likely ordered together in a future product order according to the at least one or more correlation parameters identified between different products.

The pre-organizing may be performed by an organizer module configured to detect dynamic dependencies and correlations between products or storage containers, and which is configured to send instructions to a warehouse management system which controls execution of the pre-organizing at a picking location where the storage containers are made available.

The purpose of the invention is to provide a system optimizing organization of a storage system. There could be several items stored in different storage containers with a close but unknown correlation, e.g. when a customer buys item A stored in one storage container, he is also likely to buy item B stored in another storage container. The method and system will try to identify such patterns and instead of storing the products in two storage containers containing product A and B respectively, will propose to store products A and B in the same storage container if this is favorable. A storage container storing several different products may have two or more compartments adapted to different products stored.

The picking location can be any location associated with the automated storage and retrieval system, such as a picking station operated by a robot or a human, or it can be on top of an automated storage and retrieval system where a dedicated automated harvester picks products from storage containers.

There are different ways of determining correlations between products. According to one embodiment, correlations between products are determined by comparing type of products listed in previous product orders. This is done by an organizing module comparing products that are ordered or picked at a picking station for detecting a pattern in products that are ordered or picked.

Correlation information is used for optimizing storage locations of products. By for instance storing two or three different but related products in same storage container, transferring of the products to a picking location is faster, and one container handling vehicle can be used instead of two or three, thus reducing traffic of container handling vehicles.

According to another embodiment, correlations between products are determined by determining correlations between identified storage containers holding the products. In this case, the types of products stored in the storage containers do not need to be known, only for instance a reference number of each type of product and the storage container storing it.

Correlations between products can also be identified and determined based on expected sales, dates, time and seasons.

An example of this can be when the sale of specific stored products occurs. A warehouse owner or operator can input the products for sale and the sale period to the organizer module. Based on this information, the organized module will receive information of dependencies and can initiate re-reorganizing of the products for sale such that they are placed in same storage container or in storage containers close to each other.

According to one embodiment, correlations between products are determined and improved over time by applying an Apriori algorithm, which is well known in the art, establishing associations between data representing products and how frequent products are listed in the same order.

According to one embodiment at least one dynamic dependency is detected. This is reflected in a parameter changing over time. Correlations between products may for instance be determined based on season or time of day or week. There could be certain hours in the day, certain days in the week (taco Friday), certain dates (4th of July), or seasonal periods where the correlation is stronger. The warehouse management system, WMS, can, based on the parameter, reorganize contents of storage containers during low activity periods to prepare the storage containers upfront for high activity periods. In addition, weather data could also be used to identify dependencies between certain items, like sausage and ice cream.

According to one embodiment, correlations between products includes a ratio between different products, e.g. product A is often picked with two of product B.

According to one embodiment, the warehouse management system, WMS, is instructed to reorganize storage containers, determined to have frequently ordered products, to be located close to the picking location. This means that the travel time for transporting frequently ordered products to a picking station will be short and traffic flow of frequently ordered products will be optimal.

According to one embodiment, reorganizing of products and storage containers are performed during low activity periods of the automated storage and retrieval system. This may for instance be at night when number of incoming orders usually are low.

The invention is further defined by a computer program product comprising programming instructions that when executed by a processor of an organizer module of a storage and retrieval system performs the method described above for optimizing picking of ordered products from at least one storage container handled by container handling vehicles of an automated storage and retrieval system.

The invention is further defined by a system providing pre-organizing of products stored in storage containers in an automated storage and retrieval system, comprising an organizer module configured to perform the method described above for detecting dynamic dependencies and correlations between products or storage containers, wherein the organizer module is configured to communicate with a warehouse management system which receives instructions from the organizer module for controlling execution of the pre-organizing at a picking location where the storage containers are made available.

The organizer module may be a separate module, or a module integrated in the warehouse management system, WMS. It may also be a software module located in the cloud and which is accessed by the WMS.

According to one embodiment, the system further comprises a picking device and controller configured to communicate with and receive instructions from the WMS.

### DETAILED DESCRIPTION

Embodiments of the invention will now be described in greater detail and by way of example only with reference to the figures where:

FIG. 1 shows a typical prior art automated storage and retrieval system where container handling vehicles are handling storage containers.

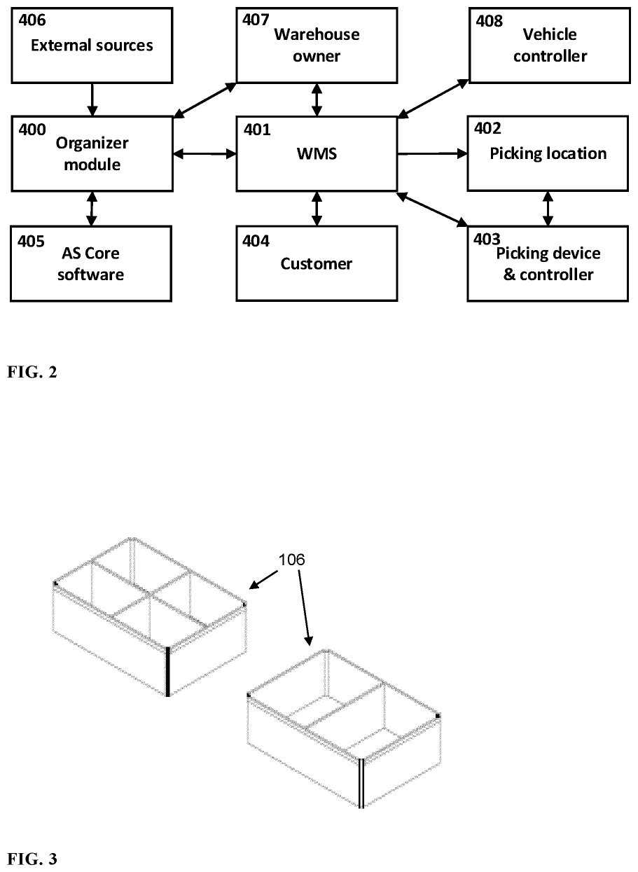

FIG. 2 shows the different connected modules for optimizing picking of ordered products from at least one storage container.

FIG. 3 illustrates storage containers with compartments for storing different types of products.

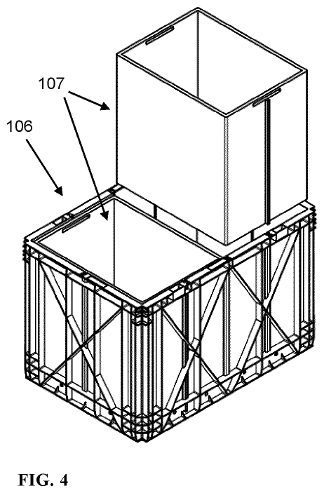

FIG. 4 illustrates a storage container with inserts making two compartments.

In overview, a method of strategically pre-organizing bin content is provided. The method identifies one or more correlations between different products, and where correlations are found, pre-organizes the products stored in a plurality of the storage containers by instructing picking operations that group products together in those storage containers. By organizing storing of different products often ordered together in one and same storage container, picking of products can be performed faster, for example. Accordingly, a method and a system are provided that can guide end-users in the process of optimizing organization of products in an automated storage and retrieval system. By presenting more than one item at the same time at a picking location, the response time for picking different products expected to be placed in same orders is reduced. This also reduces energy consumption by delivering one bin storing for instance three different types of products instead of three bins. The solution further improves traffic flow of container handling vehicles because of more efficient storing of products in storage containers.

As described in the background description above, with reference to FIG. 1, container handling vehicles operating a storage and retrieval system are controlled by a Warehouse Management System, WMS, 401 having a total overview of movements of all container handling vehicles 150 and storage containers 106 at any time. It further controls the movements of the container handling vehicles 150 by transmitting control instructions to vehicle controllers 408 in each container handling vehicle 150.

Container handling vehicles are instructed to perform a job, e.g. moving a storage container from one part of the storage and retrieval system to another. This will typically be to retrieve a storage container from a stored location and bring it to a picking station where stored products can be picked. Each job comprises moving along the rail system while transporting storage containers. Different types of products are typically stored in different storage containers. An order received and registered in the Warehouse Management System, WMS, 401, will typically contain several different types of products, either related or not.

By placing products expected to be listed in same orders, typically related products, in same storage containers, retrieving and picking of ordered product can be performed faster.

The proposed solution can use data produced at the sites and process the data using associative rules and unsupervised learning algorithms to detect pattern in products that are ordered or picked.

FIG. 2 shows the different connected modules for optimizing picking of ordered products from at least one storage container.

The Organizer module 400 is connected to the main controller in the Warehouse Management Module, WMS, 401, and will normally know contents of storage containers. This is however not required to perform the method according to the invention. It is sufficient to know which storage containers that products frequently are picked from. The Organizer module 400 can also be fed with relevant information from the warehouse owner 407. For instance, which products that are on sale, or which products that are expected to be bought together.

The AS Core Software 405 will detect dynamic dependencies and communicate this to the Organizer Module 400. The dynamic dependencies may be dynamically changing patterns reflecting correlations between identified storage containers or products stored in storage containers which may change over time. Dependencies between products can be found using the Apriori algorithm. This is well known in the field and is an algorithm finding associations and correlations between products as well as the frequency, i.e. how often products are found. The Apriori algorithm is a rule learning algorithm improving over time, and is using a relational database, which is this case contain all products ordered and stored in the automated storage and retrieval system 1. It will identify frequent individual items in the database and extending them to larger and larger item sets if those item sets appear sufficiently often in the database. The frequent item sets determined by Apriori can be used to determine association rules which highlight general trends in the database.

The Organizer module 400 can recommend reorganization to the WMS 401 that will be executed directly, or the recommendation is first presented for manual approval by an operator. The Warehouse owner 407 will typically supply info about sale statistics and approve suggested reorganizations of products in storage containers as well as placement of storage containers in the storage and retrieval system 1.

Is should also be noted that detected sales pattern according to orders may be used for suggesting alternative sales to customers.

The WMS 401 receives orders via a customer module 403. Orders typically contain different products that are stored in different storage containers. The WMS 401 is communication with the picking location 402 where picking and placing products in bins are performed. Picking and placing can be performed manually by a person or automatically by a picking devices 403 such as for instance a robot arm.

The picking device 403 can reorganize products in containers by for instance placing products from two storage containers 106 in separate compartments in one storage container 106, and where this is controlled by the WMS 401 receiving instructions and suggestions from the Organizer module 400.

The External sources module 406 keeps track of dynamic dependencies and events such as Season, yearly, daily, weekly, monthly, weather, holidays, offers/sales etc. Some of these parameters can be set automatically, while other are set manually set correlations (assumed, further adjusted by the system).

FIG. 3 illustrates storage containers 106 with compartments for storing different types of products. One storage container 106 has compartments for two different products, while the other has compartments for four different types of products, normally stored in separate storage containers 106 with only one compartment.

FIG. 4 illustrates a storage container 106 with two compartments and inserts 107 making the compartments. In this embodiment, products can be placed in an insert 107 before the insert is placed in the storage container 106. In this way, products stored in storage containers 106 can effectively be rearranged according to needs.

The resulting effect of the present invention is reduced picking/response time by presenting more than one item at the time at the picking station. It will further reduce energy consumption by delivering one bin instead of three bins. It will also reduce traffic jam due to more efficient bin-flow.

1.-15. (canceled)

16. A method of pre-organizing products stored in storage containers in an automated storage and retrieval system, the method comprising identifying at least one or more correlations between different products, and where correlations are found, pre-organizing the products stored in a plurality of the storage containers by instructing picking operations that group products together in those storage containers so that the pre-organized storage containers contain combinations of products that have been identified to be more likely ordered together in a future product order according to the at least one or more correlations identified between different products.

17. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available.

18. The method according to claim 16, wherein correlations between ordered products are determined by comparing type of products listed in previous product orders.

19. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available, wherein correlations between ordered products are determined by comparing type of products listed in previous product orders.

20. The method according to claim 16, wherein correlations between products are determined based on a current time frame and an expected sale.

21. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available, wherein correlations between products are determined based on a current time frame and an expected sale.

22. The method according to claim 16, wherein correlations between ordered products are determined by determining correlations between identified storage containers holding the products.

23. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available, wherein correlations between ordered products are determined by determining correlations between identified storage containers holding the products.

24. The method according to claim 16, wherein correlations between products are determined and improved over time by applying an Apriori algorithm establishing associations between data representing products and how frequent products are listed in same order.

25. The method according to claim 16, wherein future correlations between products are determined based on time or season.

26. The method according to claim 16, wherein correlations between products includes a ratio between different products.

27. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available, wherein correlations between products include a ratio between different products.

28. The method according to claim 16, wherein the pre-organizing is performed by an organizer module configured to detect dynamic dependencies and correlations between products or storage containers, and which is configured to send instructions to a warehouse management system which controls execution of the pre-organizing at a picking location where the storage containers are made available, wherein correlations between ordered products are determined by comparing type of products listed in previous product orders, wherein correlations between products include a ratio between different products.

29. The method according to claim 16, further comprising instructing a warehouse management system, to reorganize products in storage containers, determined to have frequently ordered products, to be located close to a picking location.

30. The method according to claim 16, further comprising instructing a warehouse management system, to reorganize products in storage containers, determined to have frequently ordered products, to be located close to a picking location, wherein reorganization of products in storage containers is performed when approved manually.

31. The method according to claim 30, where reorganizing is instructed to be performed during low activity periods of the automated storage and retrieval system.

32. A system for providing pre-organizing of products stored in storage containers in an automated storage and retrieval system, comprising an organizer module configured to:
identify at least one or more correlations between different products, and where correlations are found, pre-organize the products stored in a plurality of the storage containers by instructing picking operations that group products together in those storage containers so that the pre-organized storage containers contain combinations of products that have been identified to be more likely ordered together in a future product order according to the at least one or more correlations identified between different products,
wherein the organizer module is configured to communicate with a warehouse management system which receives instructions from the organizer module for controlling execution of the pre-organizing at a picking location where the storage containers are made available.

33. The system according to claim 32, comprising a picking device and controller configured to communicate with and receive instructions from the warehouse management system.

34. The system according to claim 32, wherein the organizer module is integrated in the warehouse management system.

35. A computer program product comprising instructions that when executed in a processor of an organizer module of a storage and retrieval system performs a method comprising:
identifying one or more correlations between different products, and where at least one or more correlations are found, pre-organizing the products stored in a plurality of storage containers by instructing picking operations that group products together in those storage containers so that the pre-organized storage containers contain combinations of products that have been identified to be more likely ordered together in a future product order according to the at least one or more correlations identified between different products.
